(19) United States
(12) Patent Application Publication
(10) Pub. No.: US 2014/0380438 A1
(43) Pub. Date: Dec. 25, 2014

(54) METHOD FOR INTEGRATING MANAGEMENT OF POSTED ARTICLES AND TERMINAL FOR THE SAME

(71) Applicant: Electronics and Telecommunications Research Institute, Daejeon (KR)

(72) Inventors: Jiyong KIM, Daejeon (KR); Sungho AHN, Daejeon (KR); Kyunghee LEE, Daejeon (KR); Seungmin PARK, Daejeon (KR)

(21) Appl. No.: 14/477,677

(22) Filed: Sep. 4, 2014

Related U.S. Application Data
(63) Continuation of application No. 12/334,486, filed on Dec. 14, 2008, now abandoned.

(30) Foreign Application Priority Data
Dec. 20, 2007 (KR) 10-2007-0134255

(51) Int. Cl. H04L 29/06

(52) U.S. Cl. CPC H04L 63/083
USPC 726/5

(57) ABSTRACT

There is provided a method for integrated management of posted articles and a terminal for the method. The method for integrated management of posted articles that is executed in a user terminal includes performing a login using an integrated ID when an integrated ID client module starts, having access to a posted article server where an article is written and requesting writing to the posted article server, transmitting a written and posted article to an integrated ID server and requesting storage of the posted article to the integrated ID server, and receiving a storage location where the posted article is stored from the integrated ID server and notifying the posted article server of the received storage location of the posted article.

### RELATED APPLICATIONS

The present application is a continuation of U.S. patent application Ser. No. 12/334,486, filed on Dec. 14, 2008, which claims priority to Korean Patent Application Serial Number 10-2007-0134255, filed on Dec. 20, 2007, which are incorporated by reference in their entirety.

### BACKGROUND OF THE INVENTION

1. Field of the Invention

The present invention relates to a method for integrated management of posted articles and a terminal for the method, and more particularly, to a method for integrated management of posted articles that can write a posted article requiring real name authentication without login and perform integrated management of posted articles, and a terminal for the method.

This work was supported by the IT R&D program of MIC/IITA [2006-S-038-02, Development of Device-Adaptive Embedded Operating System for Mobile Convergence Computing].

2. Description of the Related Art

As a real name system for Internet comes into effect, it is difficult for an anonymous user to write a reply or an article on a board. A user may log in a website and then offer an idea. However, if the user does not join the website, the user is required to perform a joining process and a login process is inconvenient to the user. For this reason, even when wanting to write a reply or an article (hereinafter, referred to as a posted article), the user frequently goes to other sites without writing an article in order to avoid performing inconvenient processes. Of course, the real name system for Internet or a request of writing posted articles after the login are necessarily needed to prevent defamation of character or the spread of groundless rumors, but negate the participation of the user on the Internet.

In the related art, there is a technology that executes user authentication for membership sites by using an authentication proxy server. In this technology, a user does not log in a membership site, and is authenticated through the authentication proxy server and obtains the right of using. The technology provides a method that is effective in preventing user's personal information from leaking. However, the technology can be used only for a specific membership site that can perform authentication between the authentication proxy server and itself, the link between the authentication proxy server and the membership site is complicated, and it is difficult to manage the link.

Further, there is a method that links posted articles of one's blog through a trackback and writes replies. This method has advantages of writing long articles without restriction. However, there are drawbacks in that a user should log in one's blog and user's personal information leaks through a blog connected through the posted articles.

Furthermore, a user writes articles on a plurality of websites. However, there is an inconvenience in that the user has access to the websites and searches posted article written by oneself in order to confirm the posted articles. There is a service that collects the user's posted articles on a specific web server and outputs the posted articles, but the service is limited to the posted articles of the specific web server.

### SUMMARY OF THE INVENTION

The present invention has been made to solve the above-mentioned problem, and it is an object of the present invention to provide a method for integrated management of posted articles and a terminal for the method. The method allows a user to simply write articles, which include a reply to a news article or an article on a board and require real name authentication or login, without a inconvenient process such as login, to perform the integrated management of the user's posted articles, and to reduce load on a web server where articles are posted.

In order to achieve the above-mentioned object, according to an embodiment of the present invention, a method for integrated management of posted articles is executed in a user terminal. The method includes the user terminal performing a login using an integrated ID when an integrated ID client module starts; the user terminal having access to a posted article server where an article is written, and requesting writing to the posted article server; the user terminal transmitting a posted article, which is written by the integrated ID client module, to an integrated ID server, and requesting storage of the posted article to the integrated ID server; and receiving a storage location, where the posted article is stored, from the integrated ID server, and notifying the posted article server of the received storage location of the posted article.

The performing of the login may include sending login information to the integrated ID server, and receiving user authentication information from the integrated ID server. The method may further include the user terminal receiving an authentication request from the posted article server, and the integrated ID client module transmitting a message for confirming the integrated ID to the posted article server in response to the authentication request.

Further, the message for confirming the integrated ID may be made on the basis of the user authentication information received from the integrated ID server in the performing of the login. The method may further include user terminal transmitting a posted address of the posted article server to the integrated ID server.

According to another embodiment of the present invention, a user terminal is connected to an integrated ID server that includes a user information DB and a posted article DB. The user terminal includes a control unit that performs a control of the user terminal, a communication unit that is used to be connected to the integrated ID server and a posted article server where an article is written through a network, and an integrated ID client module that performs a login referring to the integrated ID server and the user information DB and writes an article. The integrated ID client module has access to the posted article server and requests writing to the posted article server, transmits a written and posted article to the integrated ID server and requests storage of the posted article to the posted article DB, and receives a storage location where the posted article is stored from the integrated ID server and notifies the posted article server of the storage location of the posted article.

The login may be performed by sending login information to the integrated ID server by the integrated ID client module, and receiving user authentication information from the integrated ID server. The integrated ID client module may receive an authentication request from the posted article server, and transmit a message for confirming an integrated ID to the posted article server in response to the authentication request.

The message for confirming the integrated ID may be made on the basis of the user authentication information received from the integrated ID server in the performing of the login. The integrated ID client module may transmit a posted address of the posted article server to the integrated ID server.

According to the present invention, a user can simply write articles, which include a reply to a news article or an article on a board and require real name authentication or login, without a inconvenient process such as login. Further, it is possible to perform the integrated management of the user's posted articles, and to reduce load on a web server where articles are posted.

A user can have access to various servers and write articles by only logging in once. Further, users can actively write articles on web servers. Since the web servers do not directly store the articles, the web servers are free from the responsibility of the posted articles to some extent.

Further, a user can act on various Internet sites using one identity due to a unique ID of an integrated ID server, and does not need to join a site where the user does not frequently have access for one-time activity.

### BRIEF DESCRIPTION OF THE DRAWINGS

FIG. 1 is a view showing the configuration of a system that is used to perform a method for integrated management of posted articles according to an embodiment of the present invention; and

FIG. 2 is a flowchart illustrating steps of the method for integrated management of posted articles according to the embodiment of the present invention.

### DESCRIPTION OF THE PREFERRED EMBODIMENTS

A preferred embodiment will be described below with reference to accompanying drawings for the purpose of understanding of the present invention. The following embodiment is provided for the purpose of easier understanding of the present invention, and the present invention is not limited to the embodiment.

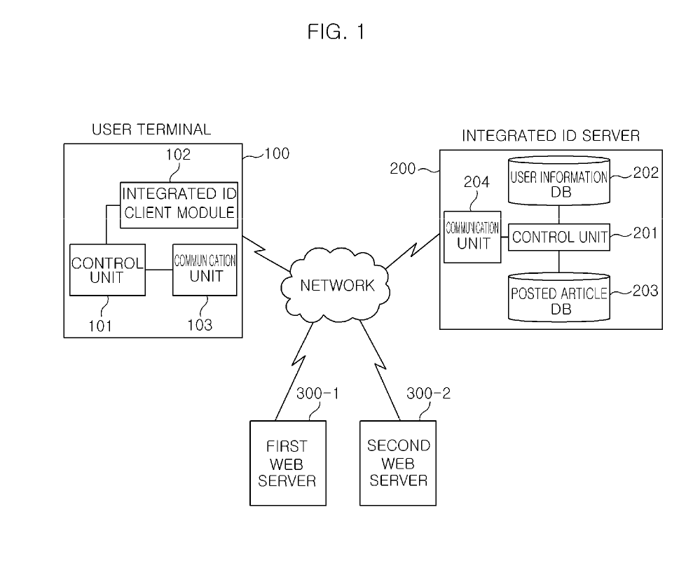

FIG. 1 is a view showing the configuration of a system that is used to perform a method for integrated management of posted articles according to an embodiment of the present invention. The system includes a user terminal 100 connected through a network, an integrated ID server 200, a first web server 300-1, and a second web server 300-2. The web server is a server where a user has access and writes an article, and may not be necessarily a web server. The number of web servers capable of being connected through a network is large, but only two web servers are shown for convenience of description.

The user terminal 100 is a terminal, such as a computer, a PDA, or a mobile phone, which is used by a user to have access to the web servers 300-1 and 300-2. The user terminal 100 includes a control unit 101, an integrated ID client module 102, and a communication unit 103. The control unit 101 performs the control of the user terminal in order to perform the method for integrated management of posted articles. The integrated ID client module 102 is a module having the form of a program. That is, the integrated ID client module is a client module that is executed in the user terminal in order to perform the method for integrated management of posted articles according to the present invention. The communication unit 103 is used so as to be connected to other servers or terminals through a network.

Further, the integrated ID server 200 is a server that performs user authentication, stores IDs and posted articles, and manages the IDs and posted articles in order to perform the method for integrated management of posted articles according to the present invention. The integrated ID server 200 includes a control unit 201, a user information DB 202, a posted article DB 203, and a communication unit 204. The control unit 201 performs the entire control of the integrated ID server 200. The user information DB 202 stores information about a user, such as a user's ID, a user's password, user's authentication information, and user's personal information. Further, the user information DB also stores information for real name authentication. The posted article DB 203 stores and manages detailed information about a posted article, such as a writer's ID, the contents of the posted article, posted time, the number of inquiries, and a posted address, for each ID. The communication unit 204 is used to be connected to other servers or terminals through a network.

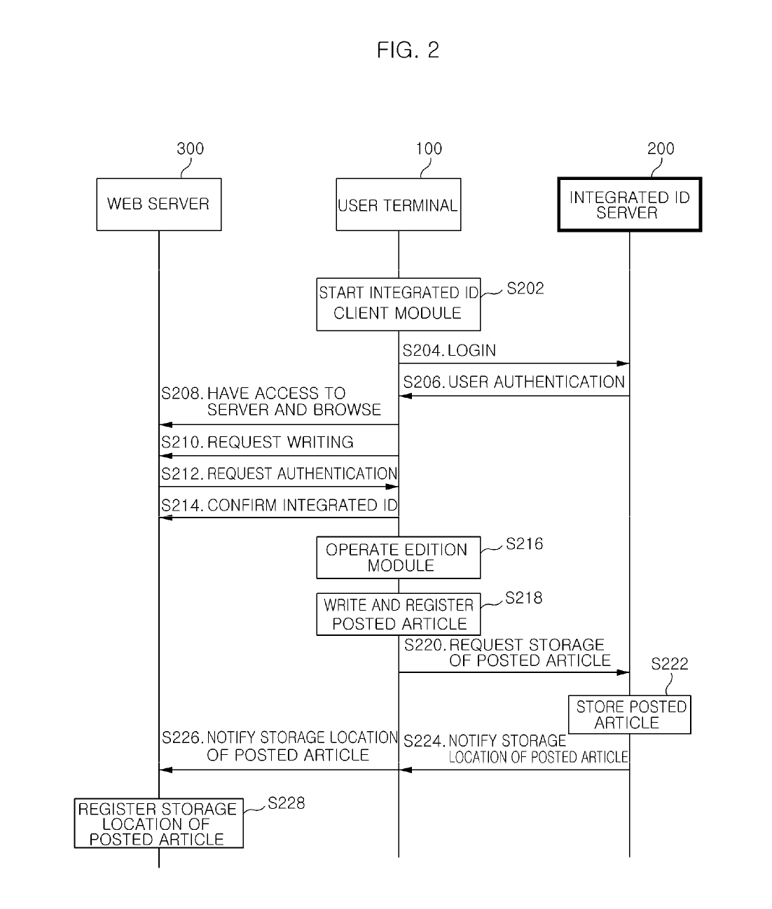

FIG. 2 is a flowchart illustrating steps of the method for integrated management of posted articles according to the embodiment of the present invention. The method for integrated management of posted articles according to the present invention will be described with reference to the configuration of the system shown in FIG. 1. FIG. 2 sequentially shows steps performed among the web server 300, the user terminal 100, and the integrated ID server 200.

First, in Step S202, the user terminal 100 starts the integrated ID client module 102. The integrated ID client module 102 may be executed on the user terminal 100 as a background process. Further, the user terminal sends login information to the integrated ID server 200 through the integrated ID client module 102 and performs a login (Step S204). The login may include real name authentication. If the integrated ID server 200 confirms user authorization with reference to the user information DB 202 on the basis of the login result, the integrated ID server 200 transmits user authentication information to the user terminal 100 in Step S206. The integrated ID client module 102 of the user terminal 100 can identify a user on the basis of the received user authentication information, and transmits/receives data with the integrated ID server 200 on the basis of the received user authentication information.

Then, in Step S208, a user has access to the web server 300 using the user terminal 100, and browses the contents posted in the web server. When wanting to write an article in the web server, in Step S210, a user requests writing to the web server 300 by using a writing button on a screen that is transmitted from the integrated ID client module 102 or the web server 300 (a posted article server where an article is written).

In Step S212, the web server 300 receiving the writing request requests authentication of the user terminal 100. In the user terminal 100 that receives the authentication request of Step S212, the integrated ID client module 102 transmits a message for confirming the integrated ID to the web server 300 in response to the authentication request on the basis of the user authentication information that is received in Step S206 (Step S214). Accordingly, the web server 300 can allow the posted article, which is written by the user terminal 100, to be registered.

The authentication process in the web server of Steps S212 and S214 is performed between the web server 300 and the user terminal 100, and the integrated ID server 200 is not related thereto. For this reason, load does not occur on the integrated ID server 200. Further, the authentication process in the web server is performed by the automated response of the integrated ID client module 102. Therefore, if requesting writing in Step S210, the user can immediately write an article.

An edition module, which is provided in the integrated ID client module 102 of the user terminal 100, is operated in Step S216. Accordingly, the user can write an article on the user terminal. In Step S218, the user completely writes the posted article by using the integrated ID client module 102, and performs a registration function of the posted article.

When the user performs the registration function of the posted article in Step S218, the detailed contents of the posted article written by the user is transmitted not to the web server 300 but to the integrated ID server 200. That is, in Step S220, the detailed contents including the contents of the posted article written by the user is transmitted and the user terminal 100 requests the storage of the posted article to the integrated ID server 200.

The integrated ID server 200 receiving the posted article-storage request stores the posted article, which is transmitted by the user, in the posted article DB 203 (Step S222). Detailed information about the posted article, such as a writer's ID (identifier), the contents of the posted article, posted time, and the number of inquiries, is stored in the posted article DB 203.

Meanwhile, writing is requested in Step S210 and the writing request is then received in the web server 300, so that it is possible to obtain address information (posted address) of the web server 300 where the article is to be posted. If the posted address obtained as described above is transmitted when the storage of the posted article is requested in Step S220, it is possible to store the address information where the article is posted in the posted article DB 203, and to find out where the posted article of each user is posted by the integrated ID server. Therefore, the posted address can be used as useful information. Furthermore, after the storage location where the posted article is stored is registered in Step S228, the web server 300 can also inform the integrated ID server 200 of the posted address.

If the posted article is completely stored in the integrated ID server 200 in Step S222, the integrated ID server 200 notifies the user terminal 100 of the storage location where the posted article is stored in the posted article DB 203. The user terminal 100, to which the storage location of the posted article is notified, notifies the web server 300 of the storage location of the posted article (Step S226). The integrated ID server 200 may directly notify the web server 300 of the storage location of the posted article.

The web server 300 registers the notified storage location of the posted article, and provides detailed contents of the posted article to users who want to browse the posted article, with reference to the registered storage location of the posted article. The storage location of the posted article may be provided on the web server 300 in the form of a link so that users perform clicking to browse the detailed contents of the posted article. Alternatively, when the posted article is displayed using a technology such as iframe, the detailed contents of the posted article may be brought into the web server 300 with reference to the storage location of the posted article, so that the posted article can be displayed to the users, similar to when the posted article is stored in the web server 300. Alternatively, when the posted article is displayed, the posted article may be directly brought from the storage location of the posted article so as to be displayed.

The posted articles written by the users are not stored in web servers while being dispersed in the web servers, but integrally stored in the integrated ID server 200 while being classified for each user. As a result, it is possible to obtain various advantages. For example, if having access to the integrated ID server 200 and performing a search, the user can extract the posted articles that were written within a predetermined period by oneself. Further, the user can confirm whether replies or responses have been written for one's posted article.

It is possible to write an article without inconvenient processes, such as real name authentication or login, and to perform the integrated management of posted articles for each user. Therefore, it is possible to improve user's convenience on the Internet and to provide various services to users.

1. A method for allowing a user who has a login account with a first server to post articles on a second server without performing an additional login process, the method comprising:
receiving, by the first server, a login request from a user terminal;
performing, by the first server, a login process in response to the login request;
transmitting, by the first server, user authentication information to the user terminal;
receiving, by the first server, information about an article from the user terminal when the user posts the article on the second server, the information of the posted article including contents of the posted article; and
storing, by the first server, the information about the posted article;
wherein the first server, the second server, and the user terminal are connected to each other through a network.

2. The method of claim 1, wherein the second server is a server that a user has access to and posts an article on.

3. The method of claim 1, wherein the information about the posted article further comprises at least one of an identifier of the user, a posting time, and a number of inquiries for the posted article.

4. The method of claim 1, wherein the second server provides the contents of the posted article to the user terminal with reference to the storage location.

5. The method of claim 1, wherein the second server provides news articles to users, and the posted article is a reply to one of the news articles.

6. The method of claim 1, wherein the second server provides the contents of the posted article to users who want to browse the posted article with reference to the storage location.

7. A method for allowing a user who has a login account with a first server to post articles on a second server without performing an additional login process, the method comprising:
receiving, by the second server, a writing request from a user terminal, the user of the user terminal having already logged in the first server;
transmitting, by the second server, an authentication request to the user terminal;
receiving, by the second server, a message for confirming an integrated ID, the message being generated by the user terminal based on user authentication information that has been transmitted from the first server to the user terminal; and
providing, by the second server, the contents of the article to users who want to browse the article with reference to the storage location.

8. The method of claim 7, wherein the second server is a server that the user has access to and posts the article on.

9. A method for posting articles on a second server with a login account on a first server, the method comprising:
performing, by a user terminal, a login process of a user with the first server;
receiving, by the user terminal, user authentication information from the first server;
sending, by the user terminal, a writing request to the second server;
receiving, by the user terminal, an authentication request from the second server;
transmitting, by the user terminal, a message for confirming an integrated ID, the message being generated by the user terminal based on the user authentication information transmitted from the first server;
receiving, by the user terminal, inputs for an article from the user; and
transmitting, by the user terminal, contents of the article to the first server.

10. The method of claim 9, further comprising:
requesting, by the user terminal, the contents of the article to the second server;
receiving, by the user terminal, the contents of the article from the first server via the second server; and
displaying, by the user terminal, the contents of the article.

11. The method of claim 9, wherein the contents of the article is received from the first server via the second server.

12. The method of claim 9, wherein the second server provides news articles to users, and the article is a reply to one of the news articles.

13. The method of claim 9, wherein the second server provides the contents of the article to users who click to browse the article with reference to the storage location.
